(19) United States
(12) Patent Application Publication
(10) Pub. No.: US 2025/0372666 A1
(43) Pub. Date: Dec. 4, 2025

(54) MANUFACTURING METHOD OF CATALYST FOR FUEL CELLS USING ELECTRON BEAM, CATALYST FOR FUEL CELLS MANUFACTRUED THEREBY, AND MEMBRANE ELECTRODE ASSEMBLY FOR FUEL CELLS INCLUDING THE SAME

(71) Applicants: Hyundai Motor Company, Seoul (KR); Kia Corporation, Seoul (KR)

(72) Inventor: Seo Hyun Yoon, Hwaseong (KR)

(21) Appl. No.: 18/926,564

(22) Filed: Oct. 25, 2024

(30) Foreign Application Priority Data
Jun. 4, 2024 (KR) 10-2024-0073091

(51) Int. Cl. H01M 4/92; H01M 8/10; H01M 8/1004

(52) U.S. Cl. CPC H01M 4/926; H01M 8/1004; H01M 2008/1095

(57) ABSTRACT

A manufacturing method of a catalyst for fuel cells using an electron beam, a catalyst for fuel cells manufactured thereby, and a membrane electrode assembly for fuel cells including the same, in which the catalyst for fuel cells is manufactured in a one-pot process to improve electrochemical performance and process efficiency of the membrane electrode assembly including the catalyst for fuel cells. The method comprises preparing a precursor dispersion liquid with a support, ceramic precursor, and metal catalyst precursor dispersed in a solvent, synthesizing the catalyst by radiating an electron beam to form ceramic and metal catalyst particles supported on the support, and heat-treating the catalyst. This process results in a catalyst that enhances the electrochemical performance and overall efficiency of the fuel cell's membrane electrode assembly.

### CROSS-REFERENCE TO RELATED APPLICATION

This application claims under 35 U.S.C. § 119(a) the benefit of Korean Patent Application No. 10-2024-0073091 filed on Jun. 4, 2024, the entire contents of which are incorporated herein by reference.

### BACKGROUND

### Technical Field

The present disclosure relates to a manufacturing method of a catalyst for fuel cells using an electron beam, a catalyst for fuel cells manufactured thereby, and a membrane electrode assembly for fuel cells including the same, in which the catalyst for fuel cells is manufactured in a one-pot process to improve electrochemical performance and process efficiency of the membrane electrode assembly including the catalyst for fuel cells.

### Background

A fuel cell is a power generation system that generates electrical energy through electrochemical reaction between hydrogen and oxygen. Fuel cells are classified into phosphoric acid fuel cells, molten carbonate fuel cells, solid oxide fuel cells, polymer electrolyte membrane fuel cells, and alkaline fuel cells, depending on the type of an electrolyte used. Although these fuel cells operate based on the same principle, they differ in the types of fuels used, the operating temperatures, the catalysts, and the electrolytes employed.

Thereamong, polymer electrolyte membrane fuel cells (PEMFCs) exhibit significantly high output characteristics, low operating temperature, short start-up time, and fast response to load changes compared to other fuel cells. In addition to these characteristics, the polymer electrolyte membrane fuel cells have the advantage of being able to produce a wide range of output, and thus have a wide application range, i.e., are used as transportable power sources, such as a power source for portable electronic devices, and transportation power sources, such as a power source for electric vehicles, as well as distributed power sources, such as a stationary power plant in houses and public buildings.

The polymer electrolyte membrane fuel cell is used in the form of a stack assembled by stacking tens to hundreds of unit cells to meet the required output level. The unit cell includes bipolar plates, gas diffusion layers (GDLs), electrodes (an anode and a cathode), and a proton exchange membrane, and an assembled stack in which the two electrodes are attached to the proton exchange membrane is called a membrane electrode assembly (MEA). The configuration and performance of the MEA are considered the core of the polymer electrolyte membrane fuel cell.

In the electrochemical reaction in a fuel cell, oxygen supplied to an anode, which is an oxidation electrode, is separated into protons and electrons through the hydrogen oxidation reaction (HOR), the protons migrate to a cathode, which is a reduction electrode, through a membrane and the electrons migrate to the cathode through an external circuit. The protons and the electrons react with oxygen gas supplied from the outside through the oxygen reduction reaction (ORR) at the cathode, generating electricity and heat and while producing water as a reaction by-product.

Here, the electrodes include a catalyst to more easily cause the redox reaction. Platinum catalysts, which exhibit high reaction activity, are mainly used as catalysts for fuel cells, but the platinum catalysts are not only limited in their reserves but also have a big obstacle to use of fuel cells due to high costs. Therefore, there is a need to develop technology that replaces the platinum catalysts, which is used in electrodes of fuel cells, or reduces the input amounts of the platinum catalysts.

Further, when a fuel cell operates, the oxidation potential of a support can increase due to the inflow of external air, potentially leading to carbon corrosion.

The above information disclosed in this Background section is only for enhancement of understanding of the background of the disclosure and therefore it may contain information that does not form the prior art that is already known in this country to a person of ordinary skill in the art.

### SUMMARY

The present disclosure has been made in an effort to solve the above-described problems associated with the existing technologies, and it is an object of the present disclosure to introduce a catalyst support having high oxidation resistance, such as ceramic particles, on a support to suppress the above-described carbon corrosion.

It is another object of the present disclosure to induce a strong metal-carrier interaction effect through a catalyst support uniformly distributed on a support to improve activity and durability of metal catalyst particles, such as platinum.

It is yet another object of the present disclosure to manufacture a catalyst for fuel cells including a metal catalyst, ceramic, and a support, which supports the metal catalyst and the ceramic, in a one-pot process to increase process efficiency and dispersibility of the metal catalyst and ceramic supported on the support.

The objects of the present disclosure are not limited to the above-mentioned objects. The objects of the present disclosure will become clearer from the following description, and may be realized by means stated in the claims and combinations thereof.

In one embodiment, the present disclosure provides a manufacturing method of a catalyst for fuel cells, including preparing a precursor dispersion liquid configured such that a support, a ceramic precursor, and a metal catalyst precursor are dispersed in a solvent, synthesizing the catalyst for fuel cells configured such that ceramic particles and metal catalyst particles are supported on the support by radiating an electron beam to the precursor dispersion liquid, and heat-treating the catalyst for fuel cells.

In an embodiment, a manufacturing method of a catalyst for fuel cell is provided, the method comprising: (a) preparing a precursor fluid composition comprising a support, a ceramic precursor, and one or more solvents; (b) exposing the precursor fluid composition to electron beam radiation to provide a catalyst for fuel cells wherein ceramic particles and metal catalyst particles are supported on the support; and (c) heat-treating the catalyst for fuel cells.

In a preferred embodiment, preparing the precursor dispersion liquid may include adding the support to the solvent and then dispersing the support in the solvent, and adding the ceramic precursor and the metal catalyst precursor to the solvent in which the support is dispersed.

In another preferred embodiment, the support may include a carbon-based support, and the carbon-based support may include any one selected from the group consisting of carbon black, carbon nanotubes, graphite, graphene, and combinations thereof.

In still another preferred embodiment, the ceramic precursor may include any one selected from the group consisting of a titanium-based compound, a cerium-based compound, a cobalt-based compound, a molybdenum-based compound, a tungsten-based compound, a chromium-based compound, and combinations thereof.

In yet another preferred embodiment, the titanium-based compound may include any one selected from the group consisting of titanium tetrachloride (TiCl₄), titanium (IV) isopropoxide (C₁₂H₂₈O₄Ti), titanium (IV) butoxide (Ti(OBu)₄), titanium diisopropoxide bis ([(CH₃)₂CHO]₂Ti(C₅H₇O₂)₂), and combinations thereof.

In still yet another preferred embodiment, the cerium-based compound may include any one selected from the group consisting of cerium (III) acetate, cerium (III) bromide, cerium (III) carbonate, cerium (III) chloride, cerium (IV) hydroxide, cerium (III) nitrate, cerium (III) sulfate, cerium (IV) sulfate, and combinations thereof.

In a further preferred embodiment, the cobalt-based compound may include any one selected from the group consisting of cobalt (II) chloride (CoCl₂), cobalt (II) sulfate (CoSO₄), cobalt (II) nitrate (Co(NO₃)₂, and combinations thereof.

In another further preferred embodiment, the molybdenum-based compound may include any one selected from the group consisting of (methyl phosphonous dichloride) pentacarbonyl molybdenum, (dimethyl phosphonous chloride) pentacarbonyl molybdenum, and a combination thereof.

In still another further preferred embodiment, the tungsten-based compound may include any one selected from the group consisting of (methyl phosphonous dichloride) pentacarbonyl tungsten, (dimethyl phosphonous chloride) pentacarbonyl tungsten, and a combination thereof.

In yet another further preferred embodiment, the chromium-based compound may include any one selected from the group consisting of (methyl phosphonous dichloride) pentacarbonyl chromium, (dimethyl phosphonous chloride) pentacarbonyl chromium, and a combination thereof.

In still yet another further preferred embodiment, the metal catalyst precursor may include any one selected from the group consisting of chloroplatinic acid (H₂PtCl₆), cis-diamineplatinum dichloride (H₆Cl₂N₂Pt), platinum (II) chloride (PtCl₂), platinum (II) bromide (PtBr₂), potassium tetrachloroplatinate (K₂(PtCl₄)), hexahydroxy platinic acid (H₂Pt(OH)₆), platinum (II) nitrate (Pt(NO₃)₂), and combinations thereof.

In a still further preferred embodiment, the solvent may include aqueous-based solvents particularly distilled water and alcohol. Exemplary alcohols include for example alcohols have 1-10 carbons such as methanol, ethanol, propanol, butanol. References herein to a solvent or the solvent are inclusive of mixtures of two or more solvents.

In a yet still further preferred embodiment, a radiation dose of the electron beam may be about 20 kGy to 60 kGy.

In still another further preferred embodiment, the ceramic particles may include any one selected from the group consisting of titanium dioxide, cerium oxide, cobalt oxide, molybdenum oxide, tungsten oxide, chromium oxide, and combinations thereof.

In yet another further preferred embodiment, the metal catalyst particles may include platinum (Pt).

In still yet another further preferred embodiment, the catalyst for fuel cells may include the ceramic particles in an amount of about 1 wt % to 9 wt % based on a total mass of 100 wt % for the combined support and ceramic particles

In a still further preferred embodiment, the catalyst for fuel cells may include the ceramic particles in an amount of about 1 wt % to 5 wt % based on a total mass of 100 wt % for the combined support and ceramic particles

In a yet still further preferred embodiment, an average particle diameter of the ceramic particles may be 20 nm or less.

In another embodiment, the present disclosure provides a catalyst for fuel cells including a carbon-based or ceramic-based support, and ceramic particles and metal catalyst particles supported on the support.

In yet another embodiment, a catalyst for fuel cells is provided. The catalyst includes a carbon-based or ceramic-based support; and titanium dioxide and platinum particles supported on the support. The catalyst for fuel cells comprises the ceramic particles in an amount of about 1 wt % to 5 wt %, based on a total mass of 100 wt % for the combined support and ceramic particles.

In yet another embodiment, the present disclosure provides a membrane electrode assembly for fuel cells including an electrolyte membrane including an ionomer, a cathode located on one surface of the electrolyte membrane, and an anode located on a remaining surface of the electrolyte membrane, wherein at least one of the cathode or the anode may include the above catalyst for fuel cells.

As discussed, the method and system suitably include use of a controller or processer.

In another embodiment, vehicles are provided that comprise an apparatus as disclosed herein.

Other aspects and preferred embodiments of the disclosure are discussed infra.

The above and other features of the disclosure are discussed infra.

### BRIEF DESCRIPTION OF THE DRAWINGS

The above and other features of the present disclosure will now be described in detail with reference to certain example embodiments thereof illustrated in the accompanying drawings which are given hereinbelow by way of illustration only, and thus are not limitative of the present disclosure, and wherein:

FIG. 1A shows a transmission electron microscope (TEM) image of a catalyst according to Comparative Example 1;

FIG. 1B shows a transmission electron microscope (TEM) image of a catalyst according to Comparative Example 2;

FIG. 1C shows a transmission electron microscope (TEM) image of a catalyst according to Example;

FIG. 2A shows a transmission electron microscope (TEM) image of the catalyst according to Example;

FIG. 2B shows a transmission electron microscope (TEM) image of a catalyst according to Comparative Example 3;

FIG. 2C shows a transmission electron microscope (TEM) image of a catalyst according to Comparative Example 4;

FIG. 3 shows results of X-ray diffraction (XRD) analysis of the catalyst of Example prepared according to the present disclosure;

FIG. 4A shows results of cyclic voltammetry of the catalysts according to Example, Comparative Example 1, and Comparative Example 2;

FIG. 4B shows results of linear sweep voltammetry of the catalysts according to Example, Comparative Example 1, and Comparative Example 2;

FIG. 5A shows a scanning electron microscope (SEM) image of the surface of an electrode manufactured using the catalyst according to Example;

FIG. 5B shows a scanning electron microscope (SEM) image of the surface of an electrode manufactured using the catalyst according to Comparative Example 3;

FIG. 5C shows a scanning electron microscope (SEM) image of the surface of an electrode manufactured using the catalyst according to Comparative Example 4; and

FIG. 6 shows results of I-V polarization performances of the catalysts according to Example, Comparative Example 1, Comparative Example 3, and Comparative Example 4.

It should be understood that the appended drawings are not necessarily to scale, presenting a somewhat simplified representation of various preferred features illustrative of the basic principles of the disclosure. The specific design features of the present disclosure as disclosed herein, including, for example, specific dimensions, orientations, locations, and shapes, will be determined in part by the particular intended application and use environment.

In the figures, reference numbers refer to the same or equivalent parts of the present disclosure throughout the several figures of the drawing.

### DETAILED DESCRIPTION

The above-described objects, other objects, advantages and features of the present disclosure will become apparent from the descriptions of embodiments given hereinbelow with reference to the accompanying drawings. However, the present disclosure is not limited to the embodiments disclosed herein and may be implemented in various different forms. The embodiments are provided to make the description of the present disclosure thorough and to fully convey the scope of the present disclosure to those skilled in the art.

In the drawings, the same or similar elements are denoted by the same reference numerals even though they are depicted in different drawings. In the accompanying drawings, the dimensions of structures may be exaggerated compared to the actual dimensions thereof, for clarity of description. In the following description of the embodiments, terms, such as “first” and “second”, may be used to describe various elements but do not limit the elements. These terms are used only to distinguish one element from other elements. For example, a first element may be named a second element, and similarly, a second element may be named a first element, without departing from the scope and spirit of the disclosure. Singular expressions may encompass plural expressions, unless they have clearly different contextual meanings.

In the following description of the embodiments, terms, such as “including”, “comprising” and “having”, are to be interpreted as indicating the presence of characteristics, numbers, steps, operations, elements or parts stated in the description or combinations thereof, and do not exclude the presence of one or more other characteristics, numbers, steps, operations, elements, parts or combinations thereof, or possibility of adding the same. In addition, it will be understood that, when a part, such as a layer, a film, a region or a plate, is said to be “on” another part, the part may be located “directly on” the other part or other parts may be interposed between the two parts. In the same manner, it will be understood that, when a part, such as a layer, a film, a region or a plate, is said to be “under” another part, the part may be located “directly under” the other part or other parts may be interposed between the two parts.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. As used herein, the term “and/or” includes any and all combinations of one or more of the associated listed items. In addition, the terms “unit”, “-er”, “-or”, and “module” described in the specification mean units for processing at least one function and operation, and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

All numbers, values and/or expressions representing amounts of components, reaction conditions, polymer compositions and blends used in the description are approximations in which various uncertainties in measurement generated when these values are obtained from essentially different things are reflected and thus it will be understood that they are modified by the term “about”, unless stated otherwise. In addition, it will be understood that, if a numerical range is disclosed in the description, such a range includes all continuous values from a minimum value to a maximum value of the range, unless stated otherwise. Further, if such a range refers to integers, the range includes all integers from a minimum integer to a maximum integer, unless stated otherwise.

In the following description of the embodiments, it will be understood that, when the range of a variable is stated, the variable includes all values within the stated range including stated end points of the range. For example, it will be understood that a range of “5 to 10” includes not only values of 5, 6, 7, 8, 9 and 10 but also arbitrary subranges, such as a subrange of 6 to 10, a subrange of 7 to 10, a subrange of 6 to 9, and a subrange of 7 to 9, and arbitrary values between integers which are valid within the scope of the stated range, such as 5.5, 6.5, 7.5, 5.5 to 8.5, and 6.5 to 9. Further, for example, it will be understood that a range of “10% to 30%” includes not only all integers including values of 10%, 11%, 12%, 13%, 30% but also arbitrary subranges, such as a subrange of 10% to 15%, a subrange of 12% to 18%, and a subrange of 20% to 30%, and arbitrary values between integers which are valid within the scope of the stated range, such as 10.5%, 15.5%, and 25.5%.

The present disclosure is intended to improve activity and durability of metal catalyst particles by reinforcing a metal-carrier interaction effect by introducing a catalyst support, such as ceramic, on a support. In addition, the present disclosure is intended to manufacture a catalyst for fuel cells including a metal catalyst, ceramic, and a support, which supports the metal catalyst and the ceramic, in a one-pot process to increase process efficiency and dispersibility of metal catalyst particles and ceramic particles supported on the support.

A manufacturing method of a catalyst for fuel cells according to the present disclosure includes preparing a precursor dispersion liquid (or precursor solution) in which a support, a ceramic precursor, and a metal catalyst precursor are dispersed in a solvent, synthesizing the catalyst for fuel cells in which ceramic particles and metal catalyst particles are supported on the support by radiating an electron beam to the precursor dispersion liquid (or precursor solution), and heat-treating the catalyst for fuel cells.

Conventionally, a catalyst for fuel cells was synthesized by supporting ceramic, such as titanium dioxide (TiO₂), on a support, and then additionally supporting a metal catalyst, such as platinum, using a predetermined reduction method (for example, an optical reduction method, a chemical reducing agent, or a polyol method), and heat treatment was performed on the synthesized catalyst for fuel cells.

In this method, since ceramic particles are preferentially disposed on the support prior to the metal catalyst, when the metal catalyst is reduced using the designated reduction method, reduction may occur on the surfaces of the insulating or non-conductive ceramic particles rather than on the surface of the support. If metal catalyst particles are reduced on the surfaces of the non-conducive ceramic particles, the insulating properties of the ceramic particles may hinder movement of electrons, thus being capable of reducing activity of the catalyst.

In the manufacturing method according to the present disclosure, the catalyst for fuel cells may be manufactured in the one-pot process by radiating the electron beam to the precursor dispersion liquid including the support, the ceramic precursor, and the metal catalyst precursor so that the ceramic and the metal catalyst are simultaneously supported on the support.

Accordingly, manufacturing efficiency of the catalyst for fuel cells may be improved, and the ceramic particles and the metal catalyst particles may be uniformly disposed on the support to improve performance of an electrode.

Hereinafter, each operation will be described in more detail.

First, the precursor dispersion liquid in which the support, the ceramic precursor, and the metal catalyst precursor are dispersed in the solvent, may be prepared.

More specifically, the preparation of the precursor dispersion liquid may include adding the support to the solvent and then dispersing the support in the solvent, and adding the ceramic precursor and the metal catalyst precursor to the solvent in which the support is dispersed.

In one embodiment, the solvent may include distilled water and alcohol. The alcohol in the solvent may function as a stabilizer which disperses the energy of the electron beam to prevent the energy from being concentrated on the ceramic precursor and the metal catalyst precursor when the electron beam is radiated to the precursor dispersion liquid. Accordingly, increases in the particle sizes of the ceramic and the metal catalyst due to rapid growth of nuclei thereof on the support, and reduction in dispersibility of the ceramic particles and the metal catalyst particles on the support may be suppressed.

The alcohol may be used without particular limitation as long as it functions as a stabilizer, and may include, for example, benzyl alcohol. Particularly, unlike alcohols, such as ethanol, benzyl alcohol may also serve as a radical scavenger, along with as a stabilizer of the metal catalyst precursor, thus being capable of more easily inducing nanonization of the ceramic particles and the metal catalyst particles.

In one embodiment, the support may be a carbon-based support or a ceramic-based support. Preferably, a carbon-based support that is easy to chemically react and has excellent electrical conductivity may be used. In addition, if a ceramic-based support is used as the support, the ceramic-based support may be different from the ceramic particles derived from the ceramic precursor.

The carbon-based support may include any one selected from the group consisting of carbon black, carbon nanotubes, graphite, graphene, and combinations thereof. Here, the type of carbon black is not particularly limited, and may include, for example, Vulcan XC 72R, Ketjen black, acetylene black, or the like.

According to the present disclosure, the catalyst for fuel cells in which ceramic particles and the metal catalyst particles are highly dispersed on the support may be prepared without separate acid treatment of the support. Accordingly, there is an advantage that environmental pollution due to acid treatment of the support may be minimized.

In the present disclosure, the ceramic precursor is a precursor of ceramic particles that are reduced by electron beam radiation and supported on a support, and may be used without particular limitation as long as it satisfies this meaning. For example, the ceramic precursor may include any one selected from the group consisting of a titanium-based compound, a cerium-based compound, a cobalt-based compound, a molybdenum-based compound, a tungsten-based compound, a chromium-based compound, and combinations thereof.

The titanium-based compound may include any one selected from the group consisting of titanium tetrachloride (TiCl₄), titanium (IV) isopropoxide (C₁₂H₂₈O₄Ti), titanium (IV) butoxide (Ti(OBu)₄), titanium diisopropoxide bis ([(CH₃)₂CHO]₂Ti(C₅H₇O₂)₂), and combinations thereof.

The cerium-based compound may include any one selected from the group consisting of cerium (III) acetate, cerium (III) bromide, cerium (III) carbonate, cerium (III) chloride, cerium (IV) hydroxide, cerium (III) nitrate, cerium (III) sulfate, cerium (IV) sulfate, and combinations thereof.

The cobalt-based compound may include any one selected from the group consisting of cobalt (II) chloride (CoCl₂), cobalt (II) sulfate (CoSO₄), cobalt (II) nitrate (Co(NO₃)₂, and combinations thereof.

The molybdenum-based compound may include any one selected from the group consisting of (methyl phosphonous dichloride) pentacarbonyl molybdenum, (dimethyl phosphonous chloride) pentacarbonyl molybdenum, and a combination thereof.

The tungsten-based compound may include any one selected from the group consisting of (methyl phosphonous dichloride) pentacarbonyl tungsten, (dimethyl phosphonous chloride) pentacarbonyl tungsten, and a combination thereof.

The chromium-based compound may include any one selected from the group consisting of (methyl phosphonous dichloride) pentacarbonyl chromium, (dimethyl phosphonous chloride) pentacarbonyl chromium, and a combination thereof.

In the manufacturing method according to the present disclosure, the ceramic particles are not directly supported on the support by simply physically mixing the ceramic and the support, and the ceramic in the form of a precursor together with the support dispersed in the solvent and are then supported on the support by radiating the electron beam, so that nanoscale ceramic particles may be uniformly dispersed on the support.

In the present disclosure, the metal catalyst precursor is a precursor of metal catalyst particles that are reduced by electron beam radiation and supported on the support, and may be used without particular limitation as long as it satisfies this meaning. For example, the metal catalyst precursor may include any one selected from the group consisting of chloroplatinic acid (H₂PtCl₆), cis-diamineplatinum dichloride (H₆Cl₂N₂Pt), platinum (II) chloride (PtCl₂), platinum (II) bromide (PtBr₂), potassium tetrachloroplatinate (K₂(PtCl₄)), hexahydroxy platinic acid (H₂Pt(OH)₆), platinum (II) nitrate (Pt(NO₃)₂), and combinations thereof.

After preparing the precursor dispersion liquid through this process, the catalyst for fuel cells in which the ceramic particles and the metal catalyst precursor are supported on the support may be synthesized by simultaneously reducing the ceramic particles and the metal catalyst precursor by radiating the electron beam to the precursor dispersion liquid.

The present disclosure may induce nuclear growth of nanoscale ceramic particles and metal catalyst particles on the surface of the support without a separate chemical reducing agent (e.g., sodium borohydride, hydrazine, or the like) by radiating the electron beam to the precursor dispersion liquid.

In one embodiment, a radiation dose of the electron beam may be 20 kGy to 60 kGy, preferably about 40 kGy. A time for which the electron beam is radiated varies depending on the amount of the catalyst for fuel cells to be manufactured and the radiation dose of the electron beam, etc., but may generally be within 1 hour. This may shorten a process time compared to the conventional polyol method of reducing a metal catalyst precursor to support metal catalyst particles on a support or the conventional method using a chemical reducing agent.

The ceramic particles supported on the support according to the present disclosure may include an oxide derived from the ceramic precursor, and the ceramic particles may include any one selected from the group consisting of titanium dioxide, cerium oxide, cobalt oxide, molybdenum oxide, tungsten oxide, chromium oxide, and combinations thereof. Preferably, the ceramic particles may include titanium dioxide (TiO₂).

Titanium dioxide is inexpensive and has abundant reserves and high stability against acids and bases, and may thus be a substitute for supports that exhibit carbon corrosion. However, since titanium dioxide exhibits insulating properties, if titanium dioxide in microscale is supported on the support, it may interfere with movement of electrons generated during the oxygen reduction reaction, thus possibly causing a decrease in the performance of a fuel cell.

Accordingly, the average particle diameter of the ceramic particles including titanium dioxide may be nanoscale. The average particle diameter of the ceramic particles including titanium dioxide may preferably be 20 nm or less, and more preferably be 10 nm or less. The lower limit of the average particle diameter of the ceramic particles is not particularly limited, and may be, for example, 1 nm or more.

As such, by supporting nanoscale ceramic particles on the support, the surface area of the insulating ceramic particles, for example, TiO₂, may be minimized to secure a movement passage of electrons, and to induce strong interaction between the metal catalyst and the carrier (i.e., the support). Thereby, even if the fuel cell is used repeatedly, movement of the metal catalyst particles may be suppressed, and durability of the fuel cell may be improved.

The metal catalyst particles are not particularly limited as long as they may be supported in the form of particles on the surface of the support and may easily induce the hydrogen oxidation reaction or the oxygen reduction reaction, and may include, for example, platinum (Pt), or an alloy of platinum (Pt) with any one of nickel (Ni), iron (Fe), cobalt (Co), chromium (Cr), manganese (Mn), and tin (Sn). Preferably, the metal catalyst particles may include platinum (Pt).

According to the present disclosure, dispersibility of the ceramic particles and the metal catalyst particles on the support may be improved by adjusting the content of the ceramic particles in the catalyst to a predetermined range.

In one embodiment, the catalyst for fuel cells may include the ceramic particles in a content of 1 wt % to 9 wt % when the sum of the masses of the support and the ceramic particles is 100 wt %. Preferably, the catalyst for fuel cells may include the ceramic particles in a content of 1 wt % to 5 wt % when the sum of the masses of the support and the ceramic particles is 100 wt %.

If the content of the catalyst for fuel cells is 10 wt % or more when the sum of the masses of the support and the ceramic particles is 100 wt %, the ceramic particles may grow on the surfaces of the metal catalyst particles rather than growing on the surface of the support to be supported thereon. In this case, dispersibility of the ceramic particles and the metal catalyst particles may be reduced. If such a catalyst for fuel cells is mixed with an ionomer and used as an electrode for fuel cells, the ionomer may aggregate with the bulk ceramic particles to form a non-uniform three-phase interface, thereby being capable of reducing efficiency of a fuel cell.

Meanwhile, the content of the metal catalyst particles in the catalyst for fuel cells is not particularly limited, and the catalyst for fuel cells may include the metal catalyst particles, for example, in a content of 30 wt % to 70 wt %, 40 wt % to 60 wt %, or 45 wt % to 55 wt % based on 100 wt % of the catalyst for fuel cells.

After synthesizing the catalyst for fuel cells by radiating the electron beam to the precursor dispersion liquid, the catalyst for cells may be heat-treated. Through such heat treatment, the bonding force between the ceramic particles and the metal catalyst particles, and the support may be strengthened.

According to the present disclosure, the nanoscale ceramic particles are uniformly dispersed on the support, and thus, reduction in dispersibility and uniformity due to agglomeration between the metal catalyst particles during high temperature heat treatment at about 700° C. or higher may be suppressed.

According to another embodiment of the present disclosure, a catalyst for fuel cells including a support and ceramic particles and metal catalyst particles supported on the support may be provided. Here, the catalyst for fuel cells is manufactured by the manufacturing method of the catalyst for fuel cells according to the present disclosure.

Accordingly, a description of each of the support, the ceramic particles, and the metal catalyst particles and relationships among the same are substantially the same as those described above in “the manufacturing method of the catalyst for fuel cells”, and a detailed of redundant content will thus be omitted.

According to yet another embodiment of the present disclosure, a membrane electrode assembly for fuel cells including an electrolyte membrane including an ionomer, a cathode located on one surface of the electrolyte membrane, and an anode located on the other surface of the electrolyte membrane, at least one of the cathode or the anode including the catalyst for fuel cells, may be provided.

The ionomer serves to provide a passage through which protons move within the electrolyte membrane, and may include a perfluorinated sulfonic acid (PFSA) ionomer or a hydrocarbon ionomer. Further, the electrolyte membrane may be one in which the ionomer is impregnated in a porous reinforcing layer, such as polytetrafluoroethylene (PTFE) or expanded polytetrafluoroethylene (e-PTFE).

Electrodes are located on both surfaces of the electrolyte membrane, and for example, the anode, which is an oxidizing electrode, is located on one surface of the electrolyte membrane, and the cathode, which is a reducing electrode, is located on the other surface of the electrolyte membrane. Here, at least one of the anode or the cathode may include the catalyst for fuel cells manufactured according to the present disclosure. Further, the electrodes may further include an ionomer, a binder, etc., in addition to the catalyst for fuel cells, if necessary.

Excluding the catalyst for fuel cells, as components included in the electrolyte membrane, the cathode, and the anode of the membrane electrode assembly, those commonly used in the art may be used.

Hereinafter, the present disclosure will be described in more detail through the following Examples and Comparative Examples. However, the technical idea of the present disclosure is not limited or restricted thereby.

### EXAMPLE

A solvent was prepared by adding benzyl alcohol to 1,000 mL of distilled water so that the content of benzyl alcohol was 10 wt %. 1 g of carbon black as a support was added to the solvent, and then sonication was performed for 1 hour.

Thereafter, a precursor dispersion liquid was prepared by adding titanium (IV) butoxide (Ti(OBu)₄), which is a ceramic precursor, and chloroplatinic acid (H₂PtCl₆), which is a metal catalyst precursor, to the solvent. Here, titanium (IV) butoxide (Ti(OBu)₄) was added so that the mass of TiO₂ was 5 wt % when the sum of the masses of carbon black and TiO₂ in a catalyst for fuel cells to be manufactured was 100 wt %, and chloroplatinic acid (H₂PtCl₆) was added so that the mass of platinum (Pt) was 50 wt % when the total mass of the catalyst for fuel cells to be manufactured, including the support, metal catalyst particles, and ceramic particles, was 100 wt %.

After the precursor dispersion liquid was injected into an electron beam reactor, the redox reaction was performed by radiating an electron beam at a radiation dose of 40 kGy for about 20 minutes at room temperature.

After terminating electron beam radiation, a catalyst for fuel cells in which the ceramic particles and the metal catalyst particles are supported on the support was synthesized through filtration and drying processes.

The synthesized catalyst for fuel cells was charged into a tube furnace under a nitrogen atmosphere, which is operated at a flow rate of 100 cc/min, and was then heat-treated at 700° C. for 1 hour. After the heat treatment of the synthesized catalyst for fuel cells was completed, the catalyst for fuel cells was naturally cooled to room temperature to manufacture a catalyst (Pt/TiO₂—C) according to Example.

### Comparative Example 1

Distilled water was prepared as a solvent. 1 g of carbon black as a support was added to the solvent, and then sonication was performed for 1 hour.

Thereafter, a precursor dispersion liquid was prepared by adding chloroplatinic acid (H₂PtCl₆), which is a metal catalyst precursor, and sodium borohydride (NaBH₄), which is a chemical reducing agent, to the solvent. Chloroplatinic acid (H₂PtCl₆) was added so that the mass of platinum (Pt) was 50 wt % when the total mass of a catalyst for fuel cells to be manufactured was 100 wt %.

A catalyst for fuel cells in which metal catalyst particles are supported on the support was synthesized by reducing chloroplatinic acid (H₂PtCl₆) by stirring the precursor dispersion liquid.

The synthesized catalyst for fuel cells was charged into a tube furnace under a nitrogen atmosphere, which is operated at a flow rate of 100 cc/min, and was then heat-treated at 700° C. for 1 hour. After the heat treatment of the synthesized catalyst for fuel cells was completed, the catalyst for fuel cells was naturally cooled to room temperature to manufacture a catalyst (Pt—C) according to Comparative Example 1.

### Comparative Example 2

A solvent was prepared by adding benzyl alcohol to 1,000 mL of distilled water so that the content of benzyl alcohol was 10 wt %. 1 g of carbon black as a support was added to the solvent, and then sonication was performed for 1 hour.

Thereafter, a precursor dispersion liquid was prepared by adding titanium dioxide (TiO₂; SIGMA ALDRICH) having an average particle diameter of 25 nm or less to the solvent to be physically mixed with carbon black, and then adding chloroplatinic acid (H₂PtCl₆), which is a metal catalyst precursor. Here, titanium dioxide (TiO₂) was added so that the mass of TiO₂ was 5 wt % when the sum of the masses of carbon black and TiO₂ in a catalyst for fuel cells to be manufactured was 100 wt %, and chloroplatinic acid (H₂PtCl₆) was added so that the mass of platinum (Pt) was 50 wt % when the total mass of the catalyst for fuel cells to be manufactured was 100 wt %.

After the precursor dispersion liquid was injected into an electron beam reactor, the redox reaction was performed by radiating an electron beam at a radiation dose of 40 kGy for about 20 minutes at room temperature.

After terminating electron beam radiation, a catalyst for fuel cells in which ceramic particles and metal catalyst particles are supported on the support was synthesized through filtration and drying processes.

The synthesized catalyst for fuel cells was charged into a tube furnace under a nitrogen atmosphere, which is operated at a flow rate of 100 cc/min, and was then heat-treated at 700° C. for 1 hour. After the heat treatment of the synthesized catalyst for fuel cells was completed, the catalyst for fuel cells was naturally cooled to room temperature to manufacture a catalyst (Pt/TiO₂—C) according to Comparative Example 2.

### Comparative Example 3

A catalyst (Pt/TiO₂—C) according to Comparative Example 3 was manufactured through the same process as in Example above, except that, when a precursor dispersion liquid was prepared by adding titanium (IV) butoxide (Ti(OBu)₄), which is a ceramic precursor, and chloroplatinic acid (H₂PtCl₆), which is a metal catalyst precursor, to a solvent, titanium (IV) butoxide (Ti(OBu)₄) was added so that the mass of TiO₂ was 10 wt % when the sum of the masses of carbon black and TiO₂ in a catalyst for fuel cells to be manufactured was 100 wt %.

### Comparative Example 4

A catalyst (Pt/TiO₂—C) according to Comparative Example 4 was manufactured through the same process as in Example above, except that, when a precursor dispersion liquid was prepared by adding titanium (IV) butoxide (Ti(OBu)₄), which is a ceramic precursor, and chloroplatinic acid (H₂PtCl₆), which is a metal catalyst precursor, to a solvent, titanium (IV) butoxide (Ti(OBu)₄) was added so that the mass of TiO₂ was 20 wt % when the sum of the masses of carbon black and TiO₂ in a catalyst for fuel cells to be manufactured was 100 wt %.

The content of each component in the catalysts according to Example, Comparative Example 3, and Comparative Example 4 is set forth in Table 1 below. For reference, in Table 1 below, “C (wt %)”, “TiO₂ (wt %)”, and “Pt (wt %)” refer to the masses of the corresponding components when the total mass of the corresponding catalyst for fuel cells including the support C, the ceramic particles TiO₂, and the metal catalyst particles Pt is set to 100 wt %, and “TiO₂/C (wt %)” indicates the mass of the ceramic particles TiO₂ when the sum of the masses of the support C and the ceramic particles TiO₂ in the corresponding catalyst for fuel cells is set to 100 wt %.

TABLE 1

| C (wt %) | TiO₂ (wt %) | Pt (wt %) | Sum (wt %) | TiO₂/C (wt %) |
|---|---|---|---|---|
| 47.3 | 2.5 | 50.2 | 100 | 5.0 |
| 44.7 | 5.1 | 50.2 | 100 | 10.2 |
| 39.8 | 10.0 | 50.2 | 100 | 20.2 |

### Test Example 1—Structure of Catalyst

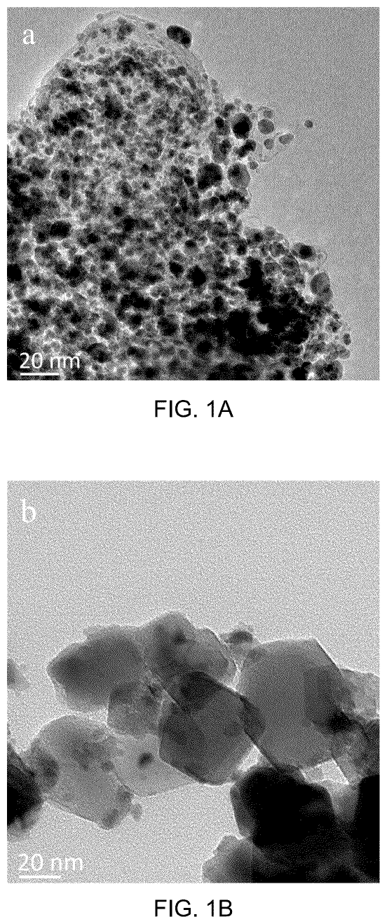

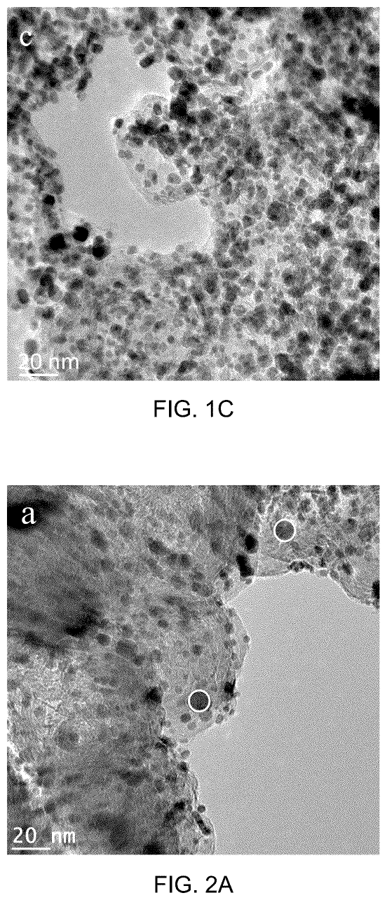

In order to determine differences among the catalysts depending on the synthesis method, the catalysts according to Comparative Example 1, Comparative Example 2, and Example were photographed with a transmission electron microscope (TEM), and the TEM images thereof are shown in FIGS. 1A, 1B, and 1C, respectively.

Referring to FIG. 1A, it may be seen that agglomeration between platinum catalyst particles occurred during the heat treatment process, and distribution of the platinum catalyst particles was non-uniform. This may cause a decrease in activity when evaluating electrochemical performance.

Referring to FIG. 1B, it may be seen that, when introducing ceramic particles onto the support, if TiO₂ was introduced directly into carbon black by simply mixing the support and the ceramic particles rather than through the reduction reaction of a ceramic precursor, homogeneous mixing of TiO₂ with carbon black was not performed completely. This may cause disconnection of an electron transport passage when an electrode including the catalyst for fuel cells is manufactured.

Referring to FIG. 1C, it may be seen that TiO₂ particles and the platinum catalyst particles were uniformly dispersed on the support. This is because it is predicted that agglomeration between platinum catalyst particles is suppressed even after heat treatment as nanoscale TiO₂ is supported on the support. Accordingly, electrochemical performance may be improved when the catalyst for fuel cells according to Example is used in an electrode.

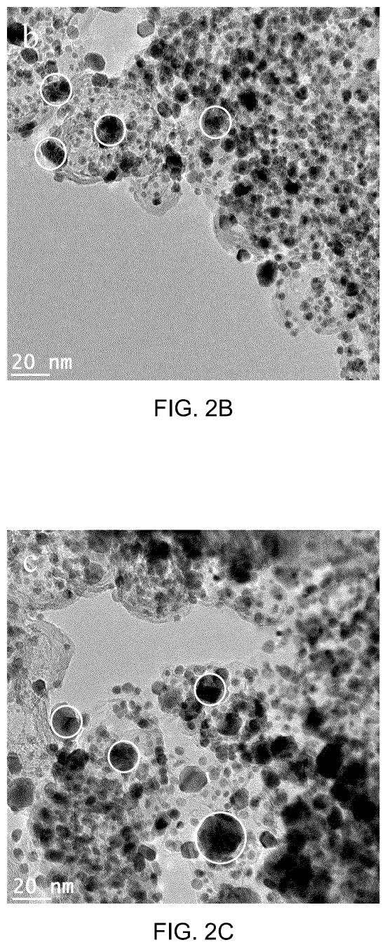

Further, in order to determine differences among the catalysts depending on the content of TiO₂ included in the synthesized catalyst for fuel cells, the catalysts according to Example, Comparative Example 3 and Comparative Example 4 were photographed with a transmission electron microscope (TEM), and the TEM images thereof are shown in FIGS. 2A, 2B, and 2C, respectively. In FIGS. 2A to 2C, areas where the TiO₂ particles and the platinum catalyst particles are clumped together are indicated by white circles.

Referring to FIG. 2A, it may be seen that, in the case of Example in which the mass of TiO₂ was 5 wt % when the sum of the mases of carbon black and TiO₂ was set to 100 wt %, the platinum catalyst particles and the TiO₂ particles were not attached to and distributed on the counterpart's surfaces, and were uniformly distributed on the surface of the support.

On the other hand, referring to FIGS. 2B and 2C showing the results for Comparative Example 3 and Comparative Example 4 which have a higher TiO₂ content than Example, it may be seen that, as the content of TiO₂ supported on the support increased, TiO₂ grew on the surfaces of the platinum particles rather than on the surface of the support. This may eventually cause a decrease in the electrochemical performance of the catalyst.

### Test Example 2—XRD Pattern Analysis of Catalyst

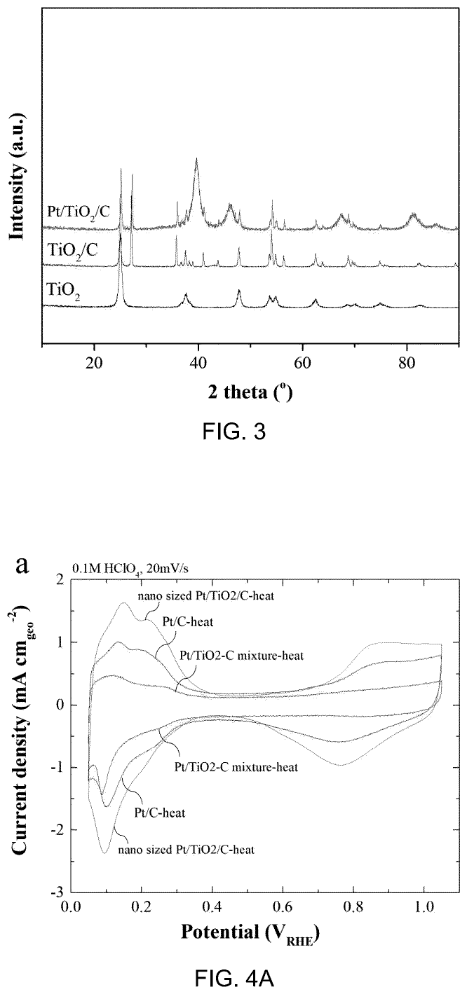

XRD pattern analysis was performed to determine the specific composition of the catalyst according to Example. At this time, in order to compare peaks, titanium dioxide (TiO₂) and a catalyst for fuel cells in which TiO₂ is dispersed on carbon black were set as controls. For reference, the catalyst for fuel cells in which TiO₂ is dispersed on carbon black was manufactured through the same process as in Example without adding chloroplatinic acid (H₂PtCl₆), which is a metal catalyst precursor. The results thereof are shown in FIG. 3.

Referring to FIG. 3, anatase TiO₂ may be confirmed in the catalyst for fuel cells (TiO₂/C) in which TiO₂ is dispersed on carbon black. Therethrough, it may be confirmed that TiO₂ nanoparticles were properly supported on the surface of the support.

In addition, it may be confirmed that, when comparing peaks of the catalyst (Pt/TiO₂/C) and the catalyst (TiO₂/C), peaks at 39.6°, 46.1°, 67.1°, and 80.9° were further observed, thus indicating that the platinum catalyst particles having a face centered cubic (FCC) structure were properly supported on the support.

### Test Example 3—Measurement of Electrical Conductivity of Catalyst

In order to evaluate the electrical conductivities of the manufactured catalysts for fuel cells, the electrical conductivities of TiO₂ powder, the catalyst according to Comparative Example 2, and the catalyst according to Example were measured through four-point probe equipment. In addition, in order to measure the electrical conductivities of the respective catalysts through the four-point probe equipment, the electrical conductivities of the catalysts were measured while varying the intensity of pressure applied during a process of processing the catalysts into the shape of a specimen. The results thereof are set forth in Table 2 below.

TABLE 2

| | | TiO₂ powder | Comp. example 2 | Example |
|---|---|---|---|---|
| | | (S/cm) | (S/cm) | (S/cm) |
| 5 | MPa | 0 | 0.743 | 2.083 |
| 10 | MPa | 0 | 2.31 | 4.91 |
| 15 | MPa | 0 | 3.39 | 8.12 |

Referring to Table 2, TiO₂ powder did not exhibit electrical conductivity even when the pressure increased, and it is understood that this is due to the insulating properties of TiO₂. Further, the catalyst according to Comparative Example 2 manufactured by physically mixing TiO₂, which is not in a precursor state, and carbon black, exhibited electrical conductivity of 3.39 S/cm when the pressure increased. In addition, the catalyst according to Example exhibited electrical conductivity of 8.12 S/cm, which was about 2.4 times improved compared to the catalyst according to Comparative Example 2.

It is predicted that this is because, even though insulating TiO₂ was present (supported) on the surface of carbon black, rapid nuclear growth of the metal catalyst particles and the ceramic particles was suppressed due to presence of benzyl alcohol as a stabilizer, and uniform nuclear growth on the support was induced by electron beam radiation.

### Test Example 4—Electrochemical Performance Evaluation of Catalyst

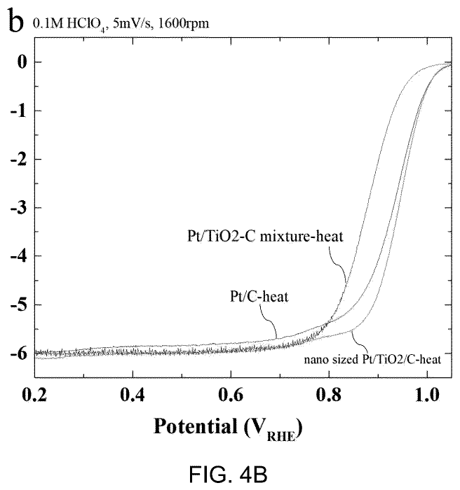

In order to evaluate the electrochemical performances of the catalysts for fuel cells, cyclic voltammetry and linear sweep voltammetry were performed on the catalysts according to Example, Comparative Example 1, and Comparative Example 2. The results thereof are shown in FIGS. 4A and 4B, respectively.

Specifically, electrochemical activity of each of the catalysts (according to Example, Comparative Example 1, and Comparative Example 2) was evaluated using cyclic voltammetry (CV, BioLogic, SP-50). Measurements were made using a half-cell, which is a three-electrode system, and each of the catalysts (according to Example, Comparative Example 1, and Comparative Example 2) was formed into the shape of a specimen electrode by applying a predetermined pressure, and used as a working electrode. 0.1M HClO₄ saturated with nitrogen was used as an electrolyte, and measurements were made at a scan rate of 20 mV/S in a voltage range of 0.05 V to 1.05 V.

In addition, the oxygen reduction reaction (ORR) of each of the catalysts (according to Example, Comparative Example 1, and Comparative Example 2) was confirmed using linear sweep voltammetry (LSV). A half-cell, which is a three-electrode system, was used to confirm the activities of catalysts, and a rotating ring disk electrode rotator (RRDE, ALS CO., Ltd., RRDE-3A) was used. 0.1M HClO₄ saturated with oxygen was used as an electrolyte, and linear sweep voltammetry analysis was performed at 1,600 rpm and a scan rate of 5 mV/S in a voltage range of 0.2 V to 1.05 V.

Referring to FIG. 4A showing results of cyclic voltammetry of the catalysts, the electrochemical surface area (ECSA) of each catalyst obtained by calculating a hydrogen-underpotential deposition (Hupd) value in the range of a potential of 0.05-0.4 was as follows.
Example: 71.8 m²/g, Comparative Example 1: 43.6 m²/g, Comparative Example 2: 18.4 m²/g

Referring to FIG. 4B showing results of linear sweep voltammetry of the catalysts, the activity performance per mass of each catalyst at 0.9 V was as follows.
Example: 0.201 A/mg, Comparative Example 1: 0.109 A/mg, Comparative Example 2: 0.034 A/mg

In the case of the catalyst according to Comparative Example 2 in which TiO₂ is simply mixed, the size of a single particle was about 25 nm, but bulk particles formed due to agglomeration between the particles form a heterogeneous mixed structure with carbon black, as shown in FIG. 4B, thereby causing a decrease in the utilization rate of platinum due to a defect in an electron transport passage.

On the other hand, in the case of the catalyst according to Example, agglomeration between particles was suppressed even after heat treatment through stabilization of the metal catalyst and ceramic by benzyl alcohol and induction of uniform nuclear growth by electron bean radiation, thereby being capable of improving the utilization rate of platinum and improving performance of the oxygen reduction reaction.

### Test Example 5—Structure of Electrode

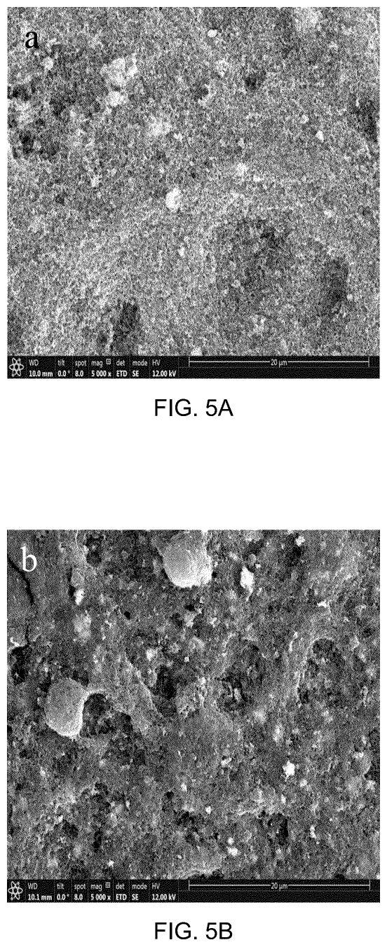

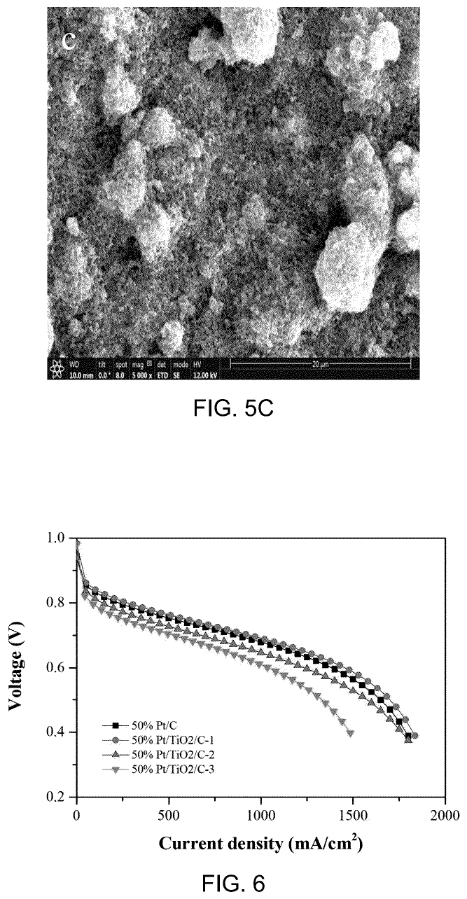

In order to examine the structure of an electrode for fuel cells to which the catalyst manufactured according to the present disclosure is applied, electrodes including the catalysts according to Example, Comparative Example 3 and Comparative Example 4 were manufactured, and then photographed with a scanning electron microscope (SEM). The electrodes for fuel cells were manufactured using a method known in the art, and specifically, the electrodes for fuel cells were manufactured by preparing a slurry by mixing Nafion (Nafion 211), which is an ionomer, and each catalyst with isopropyl alcohol, and then drying the slurry. The manufactured electrodes for fuel cells were photographed with the SEM, and the results thereof are shown in FIGS. 5A (Example), 5B (Comparative Example 3), 5C (Comparative Example 4), respectively.

Referring to FIGS. 5A to 5C, it may be seen that, as the mass of TiO₂ supported on the support increased, the area of the surface of the electrode, in which agglomeration between the ionomer and the catalyst occurs, gradually increased, and the coating properties of the electrode gradually became non-uniform. It is predicted that, as a large number of TiO₂ particles are agglomerated during the heat treatment process, distribution of the ionomer became non-uniform when manufacturing the electrode.

### Test Example 6—Electrochemical Performance Evaluation of Electrode

In order to evaluate the electrochemical performances of fuel cells to which the catalysts for fuel cells (according to Example, Comparative Example 1, Comparative Example 3, and Comparative Example 4) are applied, membrane electrode assemblies were manufactured under the conditions set forth in Table 3 below.

Here, the catalyst according to Comparative Example 1 was applied to all anodes so that the amount of platinum was 0.2 mg/cm², and each of the catalysts (according to Example, Comparative Example 1, Comparative Example 3, and Comparative Example 4) was applied to a corresponding one of cathodes so that the amount of platinum was 0.4 mg/cm².

TABLE 3

| Composition | Conditions | |
|---|---|---|
| Membrane | Nafion 211 | |
| Gas flow rate | SR: 1.5/2 (H₂/Air), 100% RH | |
| Back pressure | 1 | bar |
| Cell size | 25 | cm² |
| Pt amount | Anode: 0.2 mgₚₜ cm⁻² | |
| | Cathode: 0.4 mgₚₜ cm⁻² | |
| Temperature | 70° | C. |

Changes in current was observed by applying voltage to each membrane electrode assembly manufactured through this process, and then adjusting the voltage. The obtained results are shown in FIG. 6. Referring to FIG. 6, it may be seen that, as the mass of the TiO₂ in the catalyst for fuel cells increases, overall cell performance decreases. Referring to the results in FIG. 5C, it is predicted that, as the content of TiO₂ in the catalyst increases, the particle size increases and causes non-uniform mixing with Nafion, i.e., an ionomer, which ultimately reduces efficiency of the electrochemical reaction due to an uneven three-phase interface.

On the other hand, it may be confirmed that, in the case of Example in which the content of TiO₂ was 5 wt %, the performance of the catalyst was improved compared to general Pt/C (Comparative Example 1) not only in high voltage characteristics but also in high current characteristics. The reason for this is that it is determined that, as TiO2 particles and platinum catalyst particles are uniformly dispersed and supported on the support due to electron beam radiation and are synthesized at nanoscale, a uniform three-phase interface is formed in the electrode and influences an increase in the overall performance.

As is apparent from the above description, a catalyst for fuel cells according to the present disclosure may be manufactured in one-pot process by radiating an electron beam to a precursor dispersion liquid including a support, a ceramic precursor, and a metal catalyst precursor so that ceramic and a metal catalyst are supported on the support.

Accordingly, the manufacturing efficiency of the catalyst for fuel cells may be increased, and the ceramic and the metal catalyst may be uniformly dispersed on the support, thereby being capable of improving the performance of an electrode.

Further, rapid nuclear growth of the ceramic and the metal catalyst may be suppressed using alcohol, which is a stabilizer, as a solvent to manufacture the precursor dispersion liquid, and uniform nuclear growth may be induced due to electron beam radiation.

The effects of the present disclosure are not limited to the above-mentioned effects. The effects of the present disclosure should be understood to include all effects that may be inferred from the above description.

The disclosure has been described in detail with reference to preferred embodiments thereof. However, it will be appreciated by those skilled in the art that changes may be made in these embodiments without departing from the principles and spirit of the disclosure, the scope of which is defined in the appended claims and their equivalents.

What is claimed is:

1. A manufacturing method of a catalyst for fuel cells, comprising:
preparing a precursor dispersion liquid configured such that a support, a ceramic precursor, and a metal catalyst precursor are dispersed in a solvent;
synthesizing the catalyst for fuel cells configured such that ceramic particles and metal catalyst particles are supported on the support by radiating an electron beam to the precursor dispersion liquid; and
heat-treating the catalyst for fuel cells.

2. A manufacturing method of a catalyst for fuel cells, comprising:
preparing a precursor fluid composition comprising a support, a ceramic precursor, and one or more solvents; exposing the precursor fluid composition to electron beam radiation to provide a catalyst for fuel cells wherein ceramic particles and metal catalyst particles are supported on the support; and
heat-treating the catalyst for fuel cells.

3. The manufacturing method of claim 1, wherein preparing the precursor dispersion liquid comprises:
adding the support to the solvent and then dispersing the support in the solvent; and
adding the ceramic precursor and the metal catalyst precursor to the solvent in which the support is dispersed.

4. The manufacturing method of claim 1, wherein the support comprises a carbon-based support,
wherein the carbon-based support comprises any one selected from the group consisting of carbon black, carbon nanotubes, graphite, graphene, and combinations thereof.

5. The manufacturing method of claim 1, wherein the ceramic precursor comprises any one selected from the group consisting of a titanium-based compound, a cerium-based compound, a cobalt-based compound, a molybdenum-based compound, a tungsten-based compound, a chromium-based compound, and combinations thereof.

6. The manufacturing method of claim 5, wherein the titanium-based compound comprises any one selected from the group consisting of titanium tetrachloride (TiCl₄), titanium (IV) isopropoxide (C₁₂H₂₈O₄Ti), titanium (IV) butoxide (Ti(OBu)₄), titanium diisopropoxide bis ([(CH₃)₂CHO]₂Ti(C₅H₇O₂)₂), and combinations thereof;
wherein the cerium-based compound comprises any one selected from the group consisting of cerium (III) acetate, cerium (III) bromide, cerium (III) carbonate, cerium (III) chloride, cerium (IV) hydroxide, cerium (III) nitrate, cerium (III) sulfate, cerium (IV) sulfate, and combinations thereof;
wherein the cobalt-based compound comprises any one selected from the group consisting of cobalt (II) chloride (CoCl₂), cobalt (II) sulfate (CoSO₄), cobalt (II) nitrate (Co(NO₃)₂, and combinations thereof;
wherein the molybdenum-based compound comprises any one selected from the group consisting of (methyl phosphonous dichloride) pentacarbonyl molybdenum, (dimethyl phosphonous chloride) pentacarbonyl molybdenum, and a combination thereof;
wherein the tungsten-based compound comprises any one selected from the group consisting of (methyl phosphonous dichloride) pentacarbonyl tungsten, (dimethyl phosphonous chloride) pentacarbonyl tungsten, and a combination thereof; and
wherein the chromium-based compound comprises any one selected from the group consisting of (methyl phosphonous dichloride) pentacarbonyl chromium, (dimethyl phosphonous chloride) pentacarbonyl chromium, and a combination thereof.

7. The manufacturing method of claim 1, wherein the metal catalyst precursor comprises any one selected from the group consisting of chloroplatinic acid (H₂PtCl₆), cis-diamineplatinum dichloride (H₆Cl₂N₂Pt), platinum (II) chloride (PtCl₂), platinum (II) bromide (PtBr₂), potassium tetrachloroplatinate (K₂(PtCl₄)), hexahydroxy platinic acid (H₂Pt(OH)₆), platinum (II) nitrate (Pt(NO₃)₂), and combinations thereof.

8. The manufacturing method of claim 1, wherein the solvent comprises distilled water and alcohol.

9. The manufacturing method of claim 1, wherein a radiation dose of the electron beam is about 20 kGy to about 60 kGy.

10. The manufacturing method of claim 1, wherein the ceramic particles comprise any one selected from the group consisting of titanium dioxide, cerium oxide, cobalt oxide, molybdenum oxide, tungsten oxide, chromium oxide, and combinations thereof.

11. The manufacturing method of claim 1, wherein the metal catalyst particles comprise platinum (Pt).

12. The manufacturing method of claim 1, wherein the catalyst for fuel cells comprises the ceramic particles in an amount of about 1 wt % to 9 wt based on a total mass of 100 wt % for the combined support and ceramic particles and an average particle diameter of the ceramic particles is about 20 nm or less.

13. A catalyst for fuel cells comprising:
a carbon-based or ceramic-based support; and
ceramic particles and metal catalyst particles supported on the support.

14. The catalyst for fuel cells of claim 13,
wherein the carbon-based support comprises any one selected from the group consisting of carbon black, carbon nanotubes, graphite, graphene, and combinations thereof.

15. The catalyst for fuel cells of claim 13, wherein the ceramic particles comprise any one selected from the group consisting of titanium dioxide, cerium oxide, cobalt oxide, molybdenum oxide, tungsten oxide, chromium oxide, and combinations thereof.

16. The catalyst for fuel cells of claim 13, wherein the metal catalyst particles comprise platinum (Pt).

17. The catalyst for fuel cells of claim 13, wherein the catalyst for fuel cells comprises the ceramic particles in an amount of about 1 wt % to 9 wt %, based on a total mass of 100 wt % for the combined support and ceramic particles.

18. The catalyst for fuel cells of claim 13, wherein an average particle diameter of the ceramic particles is about 20 nm or less.

19. A catalyst for fuel cells of claim 13, wherein the catalyst comprises:
a carbon-based or ceramic-based support; and titanium dioxide and platinum particles supported on the support,
wherein the catalyst for fuel cells comprises the ceramic particles in an amount of about 1 wt % to 5 wt %, based on a total mass of 100 wt % for the combined support and ceramic particles.

20. A membrane electrode assembly for fuel cells comprising:
an electrolyte membrane comprising an ionomer;
a cathode located on one surface of the electrolyte membrane; and
an anode located on a remaining surface of the electrolyte membrane,
wherein at least one of the cathode or the anode comprises the catalyst for fuel cells of claim 13.
